(19) United States
(12) Patent Application Publication
(10) Pub. No.: US 2023/0334523 A1
(43) Pub. Date: Oct. 19, 2023

(54) MANAGEMENT SYSTEM, SERVER DEVICE AND METHOD

(71) Applicant: KPI Solutions Co., Ltd., Tokyo (JP)

(72) Inventor: Tetsuro ISHIDA, Tokyo (JP)

(21) Appl. No.: 18/338,552

(22) Filed: Jun. 21, 2023

Related U.S. Application Data
(63) Continuation of application No. PCT/JP2020/047733, filed on Dec. 21, 2020.

(51) Int. Cl. G06Q 30/0238; G06Q 50/00

(52) U.S. Cl. CPC G06Q 30/0238; G06Q 50/01

(57) ABSTRACT

A first user terminal obtains content related to a product or service which is handled in a store. A server device issues a key to the first user terminal. The first user terminal posts content into which the issued key is inserted on a social networking service. A second user terminal displays the posted content. A store terminal reads the content displayed in the second user terminal. The server device gives a reward to the first user when the key is extracted from the read content.

### CROSS-REFERENCE TO RELATED APPLICATIONS

This application is a Continuation application of PCT Application No. PCT/JP2020/047733, filed Dec. 21, 2020, the entire contents of which are incorporated herein by reference.

### BACKGROUND OF THE INVENTION

### 1. Field of the Invention

The present invention relates to a management system, a server device and a method.

### 2. Description of the Related Art

It is known that, in recent years, when a user who visited a store posts content (for example, an image) including a product which is handled in the store, etc., on a social networking service (SNS), the content exerts an advertising effect for the store.

However, to enhance such an advertising effect for a store, a mechanism for prompting a user who visited the store to post a review (review positing) is needed.

The present invention aims to provide a management system, a server device and a method which can enhance an advertising effect by making review posting easy.

### BRIEF SUMMARY OF THE INVENTION

According to one embodiment of the present invention, a management system includes a first user terminal used by a first user, a second user terminal used by a second user different from the first user, a store terminal provided in a store, and a server device which manages a social networking service used by the first user and the second user. The first user terminal obtains content related to a product or service which is handled in the store. The server device issues a key to the first user terminal. The first user terminal posts content into which the issued key is inserted on the social networking service. The second user terminal displays the posted content. The store terminal reads the content displayed in the second user terminal. The server device gives a reward to the first user when the key is extracted from the read content.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing an example of the configuration of a management system according to an embodiment.

FIG. 2 is a diagram showing an example of the hardware configuration of a server device.

FIG. 3 is a diagram showing an example of the hardware configuration of a first user terminal.

FIG. 4 is a block diagram showing an example of the functional configuration of the server device.

FIG. 5 is a diagram showing an example of the data structure of product information.

FIG. 6 is a block diagram showing an example of the functional configuration of the first user terminal.

FIG. 7 is a block diagram showing an example of the functional configuration of a store terminal.

FIG. 8 is a diagram for explaining an example of the use situation of the management system.

FIG. 9 is a sequence chart showing an example of the processing procedure of a content posting process.

FIG. 10 is a sequence chart showing an example of the processing procedure of a reward giving process.

FIG. 11 is a diagram showing the outline of the operation of the management system.

### DETAILED DESCRIPTION OF THE INVENTION

Embodiments of the present invention will be described hereinafter with reference to the accompanying drawings.

FIG. 1 shows an example of the configuration of a management system 1 (network system) according to the present embodiment. As shown in FIG. 1, the management system 1 includes a server device (management device) 10, a first user terminal 20, a second user terminal 30 and a store terminal 40. The server device 10 is communicably connected to the first user terminal 20, the second user terminal 30 and the store terminal 40 via a network 50 such as the internet.

The server device 10 has a function which manages a social networking service (SNS). In other words, the server device 10 manages information related to a plurality of users using a social networking service (hereinafter, referred to as user information), the content posted by each of the users, etc.

The first user terminal 20 is a terminal device which is used by the first user of the users of the social networking service described above.

The second user terminal 30 is a terminal device which is used by the second user of the users of the social networking service described above.

In FIG. 1, the management system 1 includes merely the first user terminal 20 and the second user terminal 30. However, the management system 1 includes a plurality of user terminals which are used by the users of the social networking service.

In the present embodiment, the first user terminal 20 and the second user terminal 30 are assumed to be, for example, smartphones. However, the first user terminal 20 and the second user terminal 30 may be other mobile terminals such as tablet terminals.

The store terminal 40 is a terminal device which is provided in a store, and is used by, for example, the staff of the store. The store terminal 40 may be, for example, a smartphone or a tablet terminal. Alternatively, the store terminal 40 may be a personal computer, etc. In the present embodiment, the store in which the store terminal 40 is provided is assumed to be, for example, a restaurant which handles various types of dishes as products. However, the store may be a store which is not a restaurant and handles other products. The store assumed in the present embodiment may include, for example, a store which is run on the internet, a store which offers a service and a visiting type store (cleaning, babysitter, etc.) regardless of whether it is a physical store. Further, the store may be a store managed by a sole proprietor or a store managed by a company.

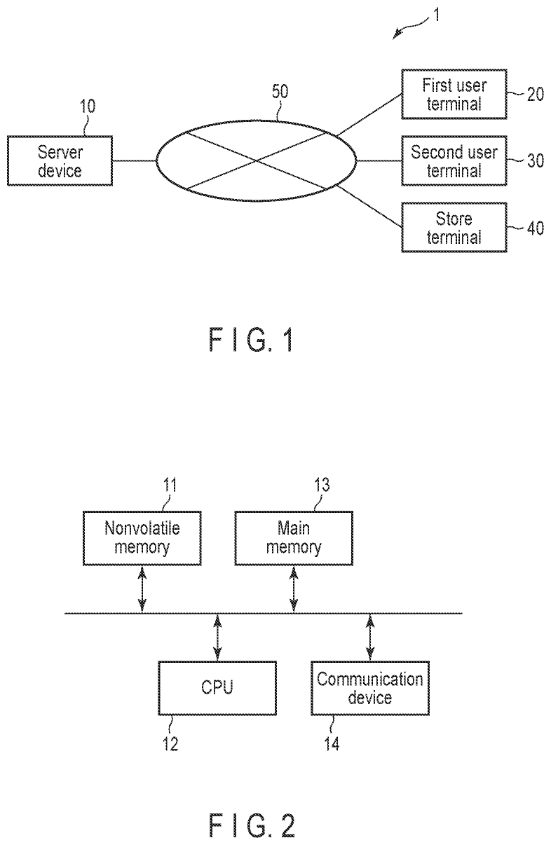

FIG. 2 shows an example of the hardware configuration of the server device 10 shown in FIG. 1. As shown in FIG. 2, the server device 10 includes a nonvolatile memory 11, a CPU 12, a main memory 13, a communication device 14, etc.

The nonvolatile memory 11 stores, for example, an operating system (OS) and various types of programs including a program for managing the social networking service described above (hereinafter, referred to as a management program).

The CPU 12 is, for example, a processor which runs various types of programs stored in the nonvolatile memory 11. The CPU 12 controls the server device 10 as a whole.

For example, the main memory 13 is used as a work area which is required when the CPU 12 runs various types of programs.

For example, the communication device 14 is a device for performing wireless communication with external devices such as the first user terminal 20, the second user terminal 30 and the store terminal 40 via the network 50.

FIG. 2 shows merely the nonvolatile memory 11 and the main memory 13. However, the server device 10 may include other storage devices such as a hard disk drive (HDD) and a solid state drive (SSD).

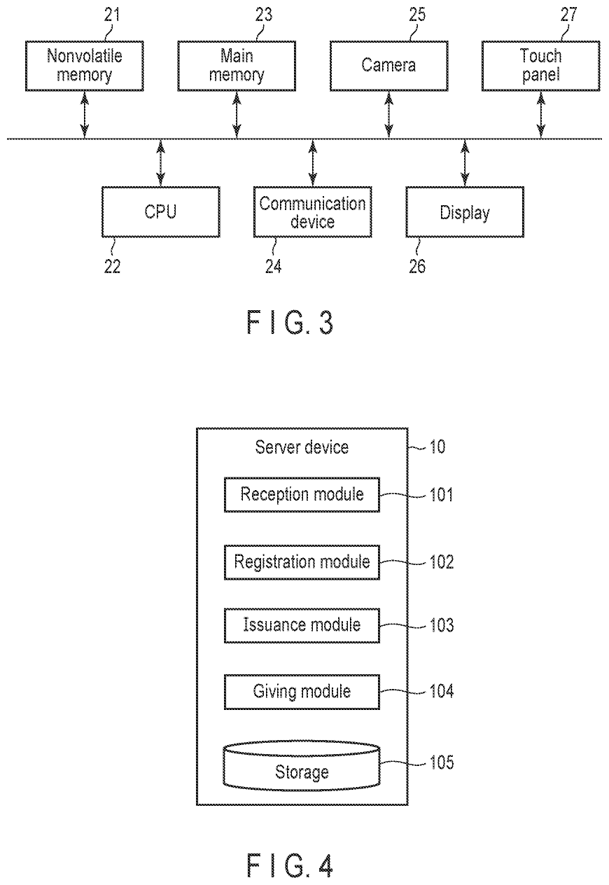

FIG. 3 shows an example of the hardware configuration of the first user terminal 20 shown in FIG. 1. As shown in FIG. 3, the first user terminal 20 includes a nonvolatile memory 21, a CPU 22, a main memory 23, a communication device 24, a camera 25, a display 26, a touch panel 27, etc.

The nonvolatile memory 21 stores, for example, an operating system (OS) and various types of programs including various type of application programs.

The CPU 22 is, for example, a processor which runs various types of programs stored in the nonvolatile memory 21. The CPU 22 controls the first user terminal 20 as a whole.

For example, the main memory 23 is used as a work area which is required when the CPU 22 runs various types of programs.

The communication device 24 includes, for example, a device for performing wireless communication with an external device such as the server device 10 via the network 50.

The camera 25 is an imaging device configured to capture various types of images (a still image or a moving image). For example, when the first user terminal 20 is a smartphone, for example, the camera 25 is incorporated into the first user terminal 20.

The display 26 is a display device configured to display various types of images, etc., by including, for example, a display panel and a drive circuit which performs display control. The image captured by the camera 25 can be displayed in the display 26.

The touch panel 27 is an input device provided so as to overlap the front surface of the display 26 and configured to, for example, detect the position specified (touched) by a finger of the user, etc., on the screen. The touch panel 27 can detect various types of operations by the first user relative to the first user terminal 20.

In FIG. 3, the hardware configuration of the first user terminal 20 is explained. Since the hardware configurations of the second user terminal 30 and the store terminal 40 are similar to the hardware configuration of the first terminal 20, detailed description thereof is omitted here. When the hardware configuration of the second user terminal 30 or the store terminal 40 is explained, FIG. 3 is used as needed.

Hereinafter, the functional configuration of the management system 1 of the present embodiment is explained. In the present embodiment, the management system 1 includes a functional configuration for giving a reward to a user who contributes to advertisement for a store by using the social networking service managed by the server device 10. In the explanation of the present embodiment, mainly, points which can be used for various purposes are given as a reward. However, the reward may be other than points as long as it can be used by the user.

In the following description, this specification mainly explains such a functional configuration of a management system for giving a reward to a user.

FIG. 4 is a block diagram showing an example of the functional configuration of the server device 10. As shown in FIG. 4, the server device 10 includes a reception module 101, a registration module 102, an issuance module 103, a giving module 104 and a storage 105.

In the present embodiment, it is assumed that the reception module 101, the registration module 102, the issuance module 103 and the giving module 104 included in the server 10 are realized by, for example, causing the CPU 12 (in other words, the computer of the server device 10) shown in FIG. 2 to execute the management program stored in the nonvolatile memory 11 (in other words, by software). It should be noted that the management program can be stored in a computer-readable storage medium in advance and distributed. For example, the management program may be downloaded into the server device 10 via the network 50.

In the explanation here, the modules 101 to 104 are realized by software. However, the modules 101 to 104 may be realized by hardware or may be realized by the combination of software and hardware.

In the present embodiment, the storage 105 is realized by, for example, the nonvolatile memory 11 shown in FIG. 2 or another storage device.

Here, for example, when the first user uses the social networking service, the first user needs to register user information related to the first user with the server device 10.

When the first user starts the use of the social networking service as described above, for example, the reception module 101 receives the user information input in the first user terminal 20 and related to the first user from the first user terminal 20. The user information received by the reception module 101 is registered with (stored in) the storage 105 by the registration module 102.

Here, this specification explains a case where the first user starts the use of the social networking service. It should be noted that a similar explanation is applied to a case where the second user starts the use of the social networking service.

The user information registered with the storage 105 should include, for example, encrypted user ID (identification information for identifying the user). It should be noted that the user information may include other information items such as the user name, email address and telephone number of the user. It is assumed that the balance (point balance) of the points (rewards) given to the user identified by the user ID is managed in the server device 10 in real time. It should be noted that the user information and the point balance described above are managed for each user who uses the social networking service managed by the server device 10.

Further, in the present embodiment, the store needs to register the products which are handled in the store in advance.

In this case, the reception module 101 receives product information indicating the products which are handled in the store from the store terminal 40. The store information received by the reception module 101 is registered with (stored in) the storage 105 by the registration module 102.

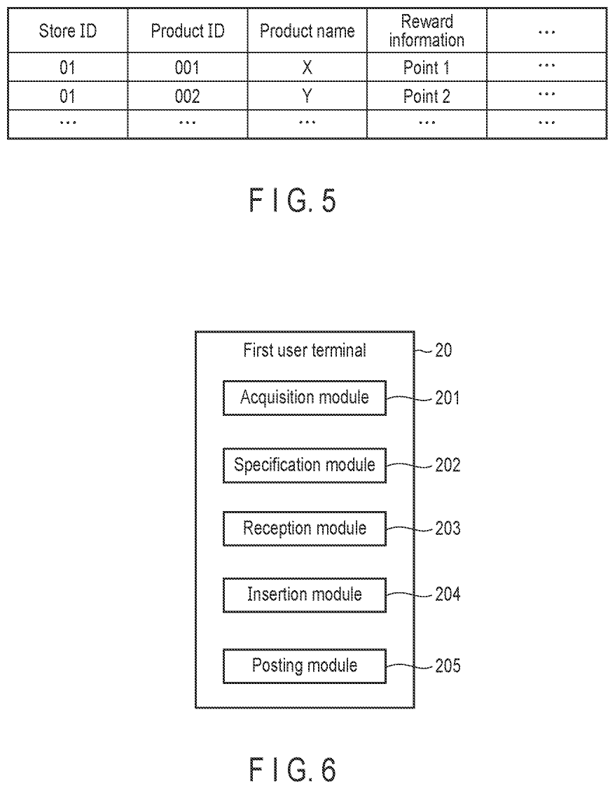

It should be noted that FIG. 5 shows an example of the data structure of the product information registered with the storage 105. As shown in FIG. 5, the product information includes product ID for identifying a product which is handled in the store, the product name of the product, reward information indicating the reward (points) given to a user who contributes to the advertisement for the product (store), etc., in association with store ID for identifying the store.

The example of FIG. 5 shows that each product information item includes a reward information item. It should be noted that the rewards indicated by the reward information items may differ depending on the product (product ID) or may be the same as each other.

In the explanation of FIG. 5, it is assumed that the product information includes store ID, product ID, a product name and reward information. It should be noted that the product information may include information (discount price or discount rate) related to the discount applied to the product, the expire date of the discount, etc. It should be noted that the information related to the discount and the expire date are information which is used when a user uses a coupon as described later.

For example, the issuance module 103 issues a key (hereinafter, referred to as a reward giving key) which is used for giving a reward to a user when the user posts content including a product which is handled in the store on the social networking service.

The giving module 104 distinguishes a user who contributes to the advertisement for the store by using the reward giving key described above, and gives a reward to the user. It should be noted that the reward given by the giving module 104 is managed in the point balance described above.

In addition to the user information and product information described above, for example, information related to the store in which the store terminal 40 is provided (for example, the place of the store and sale information) and content posted by the users of the social networking service are stored in the storage 105.

FIG. 6 is a block diagram showing an example of the functional configuration of the first user terminal 20. As shown in FIG. 6, the first user terminal 20 includes an acquisition module 201, a specification module 202, a reception module 203, an insertion module 204 and a posting module 205.

In the present embodiment, it is assumed that the acquisition module 201, the specification module 202, the reception module 203, the insertion module 204 and the posting module 205 included in the first user terminal 20 are realized by, for example, causing the CPU 22 (in other words, the computer of the first user terminal 20) shown in FIG. 3 to execute a predetermined application program stored in the nonvolatile memory 21 (in other words, by software). It should be noted that the application program is, for example, installed into the first user terminal 20 via the network 50.

The acquisition module 201 obtains content including a product which is handled in the store based on the operation performed by the first user relative to the first user terminal 20. Specifically, for example, when the first user captures an image of a product which is handled in the store by using the camera 25 provided in the first user terminal 20, the acquisition module 201 obtains the image captured by the camera 25 and including the product as content.

The specification module 202 specifies the product included in the content when the content is obtained by the acquisition module 201. The product specified by the specification module 202 is associated with the content (image) obtained by the acquisition module 201.

The reception module 203 receives the key issued by the issuance module 103 described above from the server device 10.

The insertion module 204 inserts the key received by the reception module 203 into the content obtained by the acquisition module 201. It should be noted that, in addition to the key, for example, identification information (hereinafter, referred to as first user ID) for identifying the first user is inserted into the content. The first user ID is the same as the above-described user ID included in the user information related to the first user. For example, the first user ID may be managed in the first user terminal.

The posting module 205 posts the content into which the key has been inserted by the insertion module 204 on the social networking service. In this case, the posting module 205 transmits the content to the server device 10. The content is managed in the server device 10 (storage 105).

Although omitted in FIG. 6, the first user terminal 20 can display the content posted on the social networking service managed by the server device 10 by accessing the server device 10. By this configuration, for example, the first user can browse various types of content (posts) posted by other users while using the first user terminal 20.

Here, the functional configuration of the first user terminal 20 is explained. It is assumed that the second user terminal 30 used by the second user who uses the social networking system managed by the server device 10 includes a functional configuration similar to that of the first user terminal 20 realized by running the same application program as the first user terminal 20.

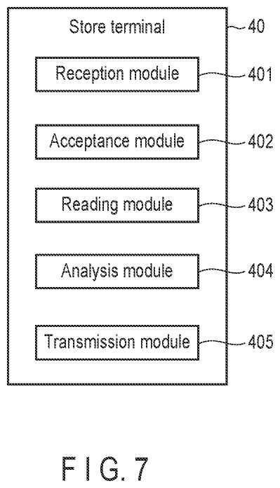

FIG. 7 is a block diagram showing an example of the functional configuration of the store terminal 40. As shown in FIG. 7, the store terminal 40 includes a reception module 401, an acceptance module 402, a reading module 403, an analysis module 404 and a transmission module 405.

Here, supposing that the store terminal 40 includes a hardware configuration similar to that of the first user terminal 20 shown in FIG. 3 described above, it is assumed that the reception module 401, the acceptance module 402, the reading module 403, the analysis module 404 and the transmission module 405 included in the store terminal 40 are realized by causing the CPU 22 (in other words, the computer of the store terminal 40) shown in FIG. 3 to execute a predetermined application program stored in the nonvolatile memory 21 (in other words, by software).

It should be noted that the application program is, for example, installed into the store terminal 40 via the network 50. The application program installed into the store terminal 40 may be the same as the application program installed into the first user terminal 20 described above (in other words, the application program for users), or may be an application program which is different from the application program for users and which is used for stores.

For example, when the content obtained by the first user terminal 20 (acquisition module 201) is posted on the social networking service, the reception module 401 receives the content.

The acceptance module 402 accepts the content (in other words, the post of the content) received by the reception module 401 based on the operation of the staff of the store relative to the store terminal 40 and gives an instruction to issue a key from the server device 10 to the first user terminal 20.

For example, the reading module 403 reads the content displayed in a user terminal (for example, the second user terminal 30) different from the first user terminal 20 (in other words, the content posted by the first user) via the camera 25 provided in the store terminal 40.

By analyzing the content read by the reading module 403, the analysis module 404 extracts (obtains) the key and the first user ID inserted into the content from the content.

The transmission module 405 transmits the key and the first user ID extracted from the content by the analysis module 404 to the server device 10. In the present embodiment, based on the key and the first user ID transmitted by the transmission module 405, a reward is given to the first user identified by the first user ID.

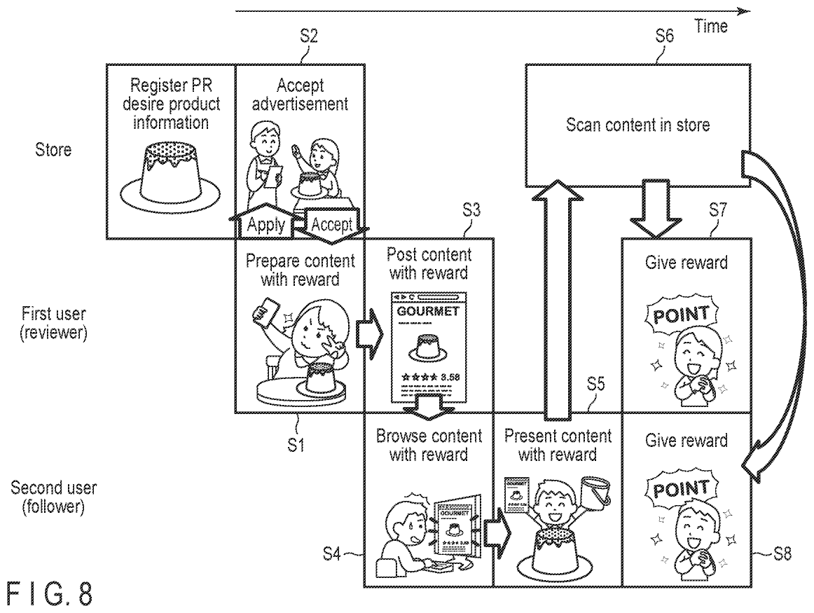

Now, this specification explains an example of the use situation of the management system 1 of the present embodiment with reference to FIG. 8. Here, it is assumed that user information related to the first user and the second user has been already registered with the server device 10 (storage 105) such that the first user and the second user can use the social networking service. Further, it is assumed that product information indicating a product which is handled in the store (a PR product whose advertisement by users is desired by the store) is registered with the server device 10 (storage 105) in advance.

Here, for example, it is assumed that the first user (reviewer) visits the store, reviews a product which is handled in the store, posts content (for example, an image) related to the product on the social networking service and performs the PR of the product.

In this case, in the first user terminal 20, content with a reward is prepared (step S1). It should be noted that this content with a reward prepared in step S1 corresponds to the content into which the reward giving key issued in the server device 10 is inserted as described above.

Subsequently, the first user can apply the advertisement of the product to the store, and the store can accept the application from the first user (step S2).

When the application from the first user is accepted by the store as described above, the content with a reward prepared in step S2 can be posted on the social networking service (step S3).

Here, it is assumed that, for example, the second user is a follower of the first user in the social networking service. The follower refers to a user who follows another user by registering the user in advance in the social network. The follower can easily browse (confirm) the posts of another user followed by the follower, etc. It should be noted that, as described above, the content posted by the first user can be browsed by the users other than the followers of the first user. However, the target for giving the reward as described later is the followers of the first user.

In this case, it is assumed that the second user browses the content with a reward posted by the first user (step S4). According to this configuration, it is possible to prompt the second user to visit the store by the advertising effect of the content with a reward.

When the second user visits the store as a result of the browse of the content with a reward described above, the second user can present the content with a reward to the staff of the store by displaying the content with a reward in the second user terminal 30 used by the second user (step S5).

The content with a reward presented by the second user in this manner is scanned by the store terminal 40 (step S6).

In this case, the server device 10 recognizes the advertising effect for the store by the first user and gives a reward (for example, points) to the first user based on the result of the scan by the store terminal 40 (step S7). It should be noted that a reward is also given to the second user who visits the store (step S8).

Now, the operation of the management system 1 of the present embodiment described above is explained in detail. Here, this specification explains each of a process which is performed when a user posts content in the management system 1 (hereinafter, referred to as a content posting process) and a process which is performed when a reward is given to a user (hereinafter, referred to as a reward giving process).

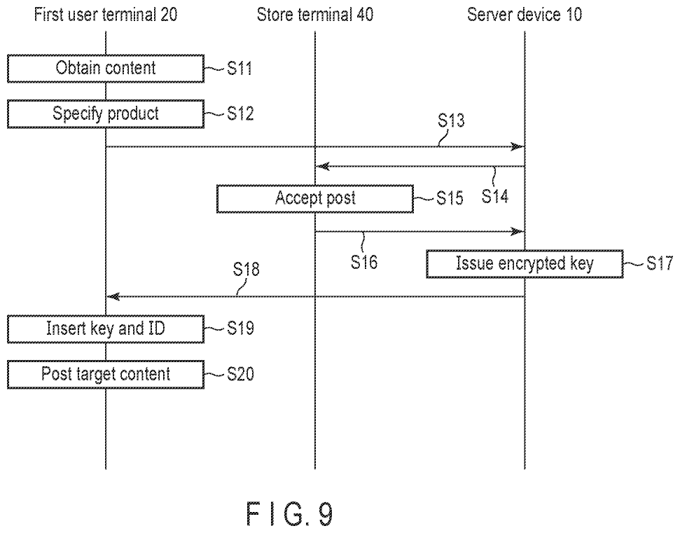

First, this specification explains an example of the processing procedure of the content posting process described above with reference to the sequence chart of FIG. 9.

Here, it is assumed that the first user visits a store and posts content including a product which is handled in the store (hereinafter, referred to as a target product). In this case, the first user can capture an image with the camera 25 provided in the first user terminal 20 by operating the first user terminal 20 and activating the camera 25.

Based on this process, the acquisition module 201 included in the first user terminal 20 obtains an image (hereinafter, referred to as target content) including the target product captured by the camera 25 (step S11).

When the process of step S11 is performed, the specification module 202 included in the first user terminal 20 specifies the target product included in the target content obtained in step S11 (step S12). It should be noted that, in step S12, for example, the target product can be specified based on the product name, etc., specified (input) by the first user in the first user terminal 20. Although not shown in FIG. 9, the first user terminal 20 may receive product information including store ID for identifying the store from the server device 10, and the target product may be specified based on the product ID which is selected by the first user from the product ID included in the product information. Further, when the target content is, for example, an image, the target product may be specified (recognized) by performing an image recognition process for the target content.

When the target product is specified in step S12, the target product is associated with the target content obtained in step S11.

When the target content obtained in step S11 is posted on a social networking service, the target content is transmitted to the server device 10 (step S13).

The target content transmitted in step S13 is received in the server device 10 and transmitted from the server device 10 to the store terminal 40 (the store terminal 40 provided in the store which handles the product associated with the target content) (step S14).

When the processes of steps S13 and S14 are performed, the acceptance for the post of the target content by the first user is applied to the store.

When the process of step S14 is performed, the reception module 401 included in the store terminal 40 receives the target content transmitted in step S14. The target content received by the reception module 401 is displayed in the store terminal 40. The staff of the store can perform the operation of accepting the post of the target content.

The acceptance module 402 included in the store terminal 40 accepts the post of the target content described above based on the operation of the staff relative to the store terminal 40 (step S15).

When the process of step S15 is performed, the acceptance module 402 notifies (transmits) the server device 10 that the post of the target content is accepted (step S16).

The notification in step S16 corresponds to an instruction to issue a reward giving key. The issuance module 103 included in the server device 10 issues a reward giving key based on the notification (step S17). This reward giving key issued in step S17 is a key which is used to give a reward to the first user (in other words, the person who posts the content), and may be, for example, an encrypted key or an encoded key. For example, the reward giving key may be usable as a coupon which can be used by another user who visits the store based on the post of the target content by the first user.

The reward giving key issued in step S17 is transmitted to the first user terminal 20 (step S18).

Subsequently, the reception module 203 included in the first user terminal 20 receives the reward giving key transmitted from the server device 10 in step S18. The insertion module 204 included in the first user terminal 20 inserts the reward giving key received by the reception module 203, the product ID for identifying the target product (the product associated with the target content) and the first user ID for identifying the first user into the target content (step S19). The product ID inserted into the target content can be obtained from, for example, the product information stored in the storage 105 included in the server device 10. For example, the first user ID for identifying the first user should be managed in the first user terminal 20.

In the explanation of the present embodiment, it is assumed that the reward giving key, the product ID and the first user ID inserted into the target content are encrypted. However, the reward giving key, the product ID or the first user ID may not be necessarily encrypted.

In the present embodiment, the process of step S19 is performed by, for example, using a data hiding technology called steganography. By this configuration, as described above, the key, the product ID and the first user ID can be embedded in (inserted into) the target content.

When the process of step S19 described above is performed, the target content in which the key, the product ID and the first user ID are synthesized (in other words, content with a reward) is prepared.

In the explanation here, the key, the product ID and the first user ID are inserted into (embedded in) the target content. It should be noted that store ID for identifying the store which handles the target product identified by the product ID and the like may be further inserted into the target content.

When the process of step S19 is performed, the posting module 205 included in the first user terminal 20 posts the target content into which the key, the product ID and the first user ID have been inserted in step S19 on the social networking service (step S20).

Although omitted in FIG. 9, when the target content is posted in step S20, the target content is managed in the server device 10 (storage 105) and can be distributed to other users. By this configuration, a plurality of users including the first user and using the social networking service can browse the target content posted by the first user.

In the data hiding technology described above, even when the target content is browsed by a plurality of users on the social networking service, the key, the product ID or the first user ID inserted into the target content cannot be viewed by the users.

In the explanation here, the post of the target content is accepted in step S15. However, for example, the staff of the store can reject the post of the target content (in other words, the application of the first user) by operating the store terminal 40 depending on the substance of the target content. If the post of the target content is rejected in this manner, it is assumed that the first user terminal 20 is notified that the post is rejected via the server device 10.

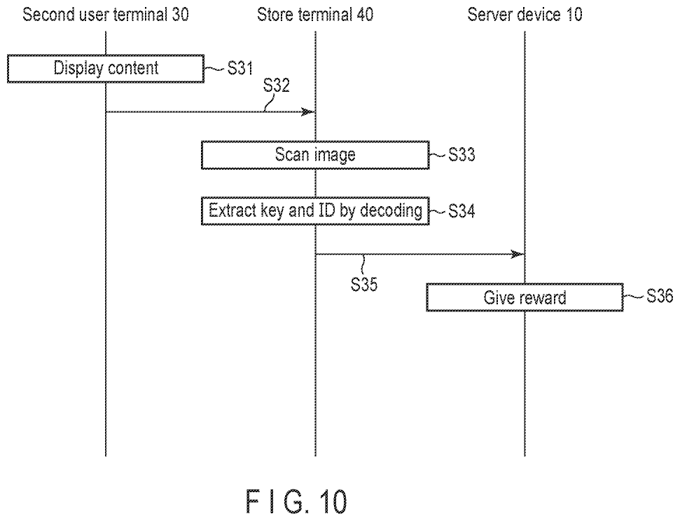

Next, this specification explains an example of the processing procedure of the reward giving process described above with reference to the sequence chart of FIG. 10.

Here, it is assumed that the second user is a follower of the first user as described above, and the target content (the content posted by the first user) is displayed in the second user terminal 30 (display 26) (step S31).

Here, as described above, product ID and the like are inserted into the target content. In step S31, for example, information related to the store which handles the target product identified by the product ID (the place of the store or the information of the sale held in the store) may be displayed together with the target content.

Here, it is assumed that the second user refers to the target content displayed in the second user terminal 30 and visits the store which handles the target product included in the target content.

In this case, the second user terminal 30 communicates with the store terminal 40 and transmits identification information for identifying the second user (hereinafter, referred to as second user ID) to the store terminal 40 (step S32). It should be noted that the second user ID should be managed in the second user terminal 30 in advance.

The second user ID transmitted in step S32 in this manner is received by the reception module 401 included in the store terminal 40.

Subsequently, the second user who visits the store can present the target content displayed in the second user terminal 30 to the staff of the store.

In this case, for example, when the staff of the store holds the camera 25 provided in the store terminal 40 over the target content displayed in the second user terminal 30, the reading module 403 included in the store terminal 40 reads the target content (image) (step S33).

When the process of step S33 is performed, the analysis module 404 included in the store terminal 40 extracts the reward giving key, the product ID and the first user ID inserted into the target content read in step S33 from the target content by analyzing the target content (step S34). It is assumed that, when the reward giving key, the product ID and the first user ID are encrypted, the reward giving key, the product ID and the first user ID are extracted by performing a decoding process.

Here, for example, in a case where the reward giving key inserted into the target content (in other words, the reward giving key extracted in step S34) has a function as a coupon as described above, when the process of step S34 is performed, the content of the coupon is displayed in the store terminal 40 (display 26), and the second user can, for example, purchase the target product with the coupon.

When the reward giving key is extracted in step S34, the second user ID received from the second user terminal 30 as described above and the reward giving key, the product ID and the first user ID extracted in step S34 are transmitted to the server device 10 (step S35).

When the process of step S35 is performed, the reception module 101 included in the server device 10 receives the reward giving key, the product ID, the first user ID and the second user ID which are transmitted from the store terminal 40 in step S35. When the reward giving key transmitted from the store terminal 40 is received by the reception module 101 in the server device 10 in this manner, the server device 10 can recognize the first user identified by the first user ID received by the reception module 101 in a similar manner as a user who contributes to the advertisement for the store, and can know that the second user identified by the second user ID received by the reception module 101 visits the store by the advertising effect of the target content posted by the first user.

In this case, the giving module 104 included in the server device 10 gives a reward (points) to the first user identified by the first user ID received by the reception module 101 (in other words, a user who contributes to the advertisement for the store) (step S36).

In this step S36, the giving module 104 obtains the reward information included in the product information in association with the product ID received by the reception module 101 with reference to the storage 105 and gives the points indicated by the reward information to the first user. To give points to the first user indicates to add the points given to the first user (the points indicated by the reward information) to the point balance of the first user managed in the server device 10.

In the explanation here, points are given to the first user. It should be noted that points may be also given to the second user (in other words, a user who visits the store by the advertising effect of the post of the first user). In this case, the points (the number of points) given to the second user may be either the same as or different from the points (the number of points) given to the first user.

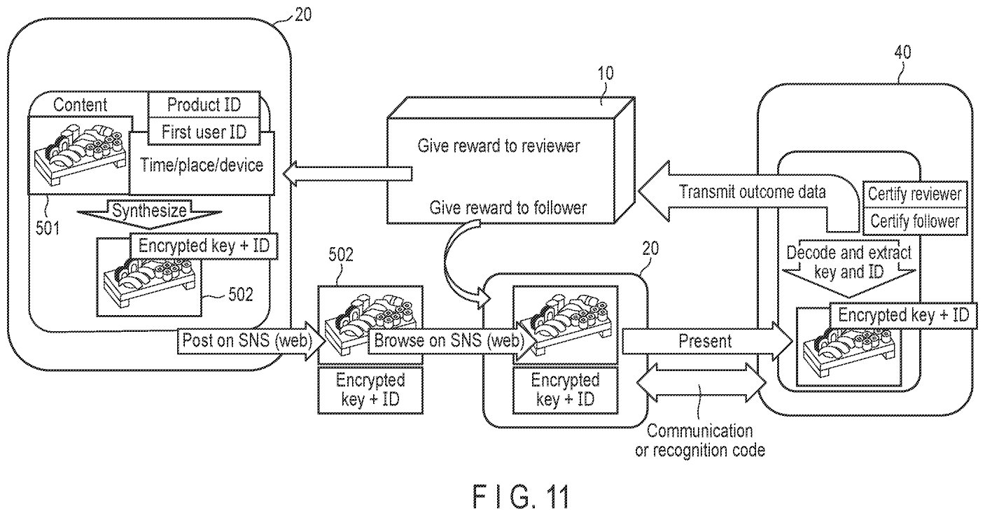

Here, FIG. 11 shows the outline of the operation (the content posting process and the reward giving process) of the management system 1 described above.

As shown in FIG. 11, the target content 501 obtained in the first user terminal 20 is combined with a reward giving key, product ID and first user ID (an encrypted key+ID) as described above, and is posted on a social networking service (web) as target content 502 into which the reward giving key, the product ID and the first user ID have been inserted.

The target content 502 may include, for example, the place and time in which the target content 501 is obtained (in other words, the captured place and captured time of the image) or device ID for identifying the first user terminal 20 which obtains the target content 501.

The target content 502 posted on the social networking service is browsed by the second user when it is displayed in the second user terminal 30.

Here, when the second user visits the store, and the target content 502 displayed in the second user terminal 30 is presented to the staff of the store, the store terminal 40 recognizes the first user (in other words, certifies the reviewer) by reading (scanning) the target content 502 and decoding and extracting the first user ID inserted into the target content 502.

When the second user ID is transmitted from the second user terminal 30 to the store terminal 40, the store terminal 40 recognizes the second user (in other words, certifies the follower) by receiving the second user ID. In the present embodiment, the second user ID is transmitted from the second user terminal 30 to the store terminal 40. However, it is assumed that communication is performed between the second user terminal 30 and the store terminal 40 such that individuals can be mutually recognized. In this case, for example, communication (short-range communication) based on near field communication (NFC) could be performed. However, communication using another communication technique may be performed.

In the explanation here, communication is performed between the second user terminal 30 and the store terminal 40 to recognize the second user. It should be noted that, for example, a recognition code such as a two-dimensional code issued for the target content 502 may be displayed in the second user terminal 30, and the second user may be recognized (in other words, mutual authentication may be performed) by reading the recognition code.

In this case, the first user ID and the second user ID described above are transmitted from the store terminal 40 to the server device 10 as an advertising effect (outcome data) for the store in the social networking service. The server device 10 can give points (reward) to the first user who is a reviewer and the second user who is a follower.

In the explanation of the present embodiment, when the target content is merely displayed in the second user terminal 30 and presented to the staff of the store, points are given to the first user and the second user. However, for example, only when the second user purchases the target product or another product, etc., in the store (in other words, the second user performs a predetermined settlement use action), a reward may be given.

Here, this specification explains a case where, for example, the second user who browsed content including a product which is handled in a physical store (real store) visits the physical store. However, as described above, the store in the present embodiment is not limited to a physical store and may be a store which is run on the internet, etc. In this case, instead of presenting content, content (encrypted data) may be uploaded, and telecommunication (for example, communication via a mobile communication network) may be performed between the second user terminal 30 and the store terminal 40.

As described above, in the present embodiment, when content including a product which is handled in the store is obtained in the first user terminal 20, an encrypted reward giving key is issued from the server device 10 to the first user, and content into which the issued reward giving key has been inserted is posted on the social networking service. In the present embodiment, the content posted on the social networking service is displayed in the second user terminal 30. When the content is read by the store terminal 40, and the reward giving key is extracted from the read content, a reward (for example, points) is given to the first user. In the present embodiment, it is assumed that the reward giving key is inserted into (embedded in) the content by, for example, a data hiding technology such as steganography.

In the present embodiment, when, for example, the first user posts content for advertising a product which is handled in the store on the social networking service, and the second user who browses the content visits the store, a reward is given to the first user. Thus, it is possible to prompt the users of the social networking service to post content including a product to advertise the store. In this configuration, it is possible to enhance an advertising effect for the store by allowing the users to easily post a review via the social networking service.

Further, in the present embodiment, a reward may be given to the second user who visits the store after browsing the content posted by the first user. In this configuration, it is possible to prompt the users who browse the content of advertising a product which is handled in the store to visit the store. Thus, an increase in the number of visitors of the store can be expected.

When the reward giving key inserted into the content can be used as a coupon, it is possible to further prompt the users who browse the content to visit the store.

The present embodiment is configured such that a reward giving key is issued when the content obtained in the first user terminal 20 (in other words, an image captured by the first user, etc.) is accepted based on the operation by the staff of the store relative to the store terminal 40. In this configuration, for example, it is possible to avoid a situation in which a reward giving key is issued for content which is not desirable for the store (for example, content whose advertising effect cannot be expected).

In the present embodiment, the reward may differ depending on the product included in the content. In this configuration, for example, an increase in the number of posts of content including the intended product of the store (in other words, the number of advertisements of the product) can be expected by setting the reward of the product whose advertisement is desired by the store so as to be high.

In the explanation of the present embodiment, mainly, the reward given to users is points. It should be noted that the reward may be electronic money, a coupon, etc., as long as it is given to users.

In the explanation of the present embodiment, an image (data) is posted as content. It should be noted that the image may be a still image or may be a moving image. As long as a reward giving key can be inserted by the data hiding technology (for example, steganography) described above, the content posted on the social networking service may be data in another format such as sound or text.

In the explanation of the present embodiment, content is posted on the social networking service. It should be noted that the present embodiment may be applied to a case where content is published on the internet (for example, a website or a blog) as long as the content contributes to the advertisement for the store.

Further, in the explanation of the present embodiment, the server device 10, the first user terminal 20 and the store terminal 40 include the functional configurations of FIG. 4, FIG. 6 and FIG. 7, respectively. However, the functional configuration included in each of the server device 10, the first user terminal 20 and the store terminal 40 may be different from that of FIG. 4, FIG. 6 or FIG. 7.

Specifically, in the explanation of the present embodiment, the first user terminal 20 includes the specification module 202, and the product included in the content obtained by the first user terminal 20 (acquisition module 201) is specified by the specification module 202. However, the server device 10 may include a functional module corresponding to the specification module 202, and for example, the product included in the content may be specified on the server device 10 side.

Similarly, in the explanation of the present embodiment, the first user terminal 20 includes the insertion module 204, and the insertion module 204 inserts a reward giving key to content. However, the server device 10 may include a functional module corresponding to the insertion module 204, and the process of inserting a reward giving key to content may be performed on the server device 10 side.

In the explanation of the present embodiment, the store terminal 40 includes the analysis module 404, and the analysis module 404 analyzes content (in other words, extracts a reward giving key, etc.). However, the server device 10 may include a functional module corresponding to the analysis module 404, and for example, the content read in the store terminal 40 may be analyzed on the server device 10 side.

As described above, the subject which performs each process explained in the present embodiment may be appropriately changed based on, for example, the design of the management system.

It should be noted that the method described in the above embodiment can be stored in, as a program which can be run by a computer, a storage medium such as a magnetic disk (a floppy [registered trademark] disk, a hard disk, etc.), an optical disk (CD-ROM, DVD, etc.), a magneto-optical disk (MO) or a semiconductor memory and distributed.

The storage format of the storage medium may be any format as long as the storage medium can store a program and can be read by a computer.

The operating system (OS) which operates on a computer based on an instruction of a program installed from a storage medium into the computer and middleware such as database management software and network software may perform part of the processes to realize the present embodiment.

Further, in the present invention, the storage medium is not limited to a medium which is independent from a computer, and includes a storage medium which stores or temporarily stores a program transmitted by a LAN, the internet, etc., by downloading it.

The number of storage media is not limited to one. Even a case where the process of the present embodiment is performed from a plurality of media is included in the storage medium of the present invention. The media may include any configuration.

In the present invention, the computer performs each process in the present embodiment based on a program stored in a storage medium and may include any configuration like a single device such as a personal computer or a system in which a plurality of devices are connected by a network.

In the present invention, the computer is not limited to a personal computer and includes an operation processor included in an information processing device, a microcomputer, etc. The computer collectively means a device or apparatus which can realize the function of the present invention by a program.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A management system comprising:
a first user terminal used by a first user,
a second user terminal used by a second user different from the first user,
a store terminal provided in a store, and
a server device which manages a social networking service used by the first user and the second user, wherein
the first user terminal obtains content related to a product or service which is handled in the store;
the server device issues a key to the first user terminal;
the first user terminal posts content into which the issued key is inserted on the social networking service;
the second user terminal display the posted content;
the store terminal reads the content displayed in the second user terminal; and
the server device gives a reward to the first user when the key is extracted from the read content.

2. A management system comprising:
a first user terminal used by a first user,
a second user terminal used by a second user different from the first user,
a store terminal managed by a store, and
a server device which manages a social networking service used by the first user and the second user, wherein
the first user terminal obtains content related to a product or service which is handled in the store;
the server device issues a key to the first user terminal;
the first user terminal posts content into which the issued key is inserted on the social networking service;
the second user terminal displays the posted content in the second user terminal;
the second user terminal transmits the displayed content to the store terminal; and
the server device gives a reward to the first user when the key is extracted from the transmitted content.

3. The management system of claim 1, wherein
the server device further gives a reward to the second user.

4. The management system of claim 1, wherein
the key is used as a coupon.

5. The management system of claim 1, wherein
the server device issues the key when the content is accepted by staff of the store.

6. The management system of claim 1, wherein
the key is embedded in the content by steganography.

7. The management system of claim 1, wherein
the reward differs depending on the product or service.

8. A server device which is used in the management system of claim 1.

9. A method performed by a management system comprising a first user terminal used by a first user, a second user terminal used by a second user different from the first user, a store terminal provided in a store, and a server device which manages a social networking service used by the first user and the second user, the method comprising:
obtaining content related to a product or service which is handled in the store in the first user terminal;
issuing a key from the server device to the first user terminal;
posting content into which the issued key is inserted on the social networking service from the first user terminal;
displaying the posted content in the second user terminal;
reading the content displayed in the second user terminal in the store terminal; and
giving a reward to the first user when the key is extracted from the read content.
